(19) United States
(12) Patent Application Publication
(10) Pub. No.: US 2009/0119618 A1
(43) Pub. Date: May 7, 2009

(54) User-specified configuration of prediction services

(76) Inventors: David Everton Norman, Bountiful, UT (US); Richard Stafford, Bountiful, UT (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/983,169

(22) Filed: Nov. 6, 2007

(51) Int. Cl. G06F 3/048

(52) U.S. Cl. 715/812

(57) ABSTRACT

Methods and systems for facilitating user-specified configuration of prediction services in a manufacturing facility. In one embodiment, a workflow user interface is presented to allow a user to specify a workflow for providing predictions pertaining to a future of a manufacturing facility. The workflow identifies a sequence of operations to be performed for providing the predictions. In addition, the user can specify properties for each operation in the workflow user interface. The workflow with the properties are then stored in a repository for subsequent execution in response to a workflow trigger.

### FIELD OF THE INVENTION

Embodiments of the present invention relate generally to managing a manufacturing facility, and more particularly to facilitating user-specified configuration of prediction services in a manufacturing facility.

### BACKGROUND OF THE INVENTION

In an industrial manufacturing environment, accurate control of the manufacturing process is important. Ineffective process control can lead to manufacture of products that fail to meet desired yield and quality levels, and can significantly increase costs due to increased raw material usage, labor costs and the like.

When managing a manufacturing facility, complicated decisions need to be made about what an idle equipment should process next. For example, a user may need to know whether a high-priority lot will become available in the next few minutes. Current Computer Integrated Manufacturing (CIM) systems only provide information about the current state of the facility to aid in making those decisions. Information about what the facility might look like in the future is not immediately available and calculating it on the fly is expensive. This limits the sophistication of decisions that can be made by the CIM system. In particular, producing a schedule for the facility requires this sort of predictive information and calculating it can be a significant portion of the cost of producing a schedule.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a prediction system.

FIG. 2 is a block diagram of one embodiment of a configuration tool that facilitates user-specified configuration of prediction services in a manufacturing facility.

FIG. 3 is a flow diagram of one embodiment of a method for facilitating user-specified configuration of prediction services in a manufacturing facility.

FIG. 4 illustrates an exemplary workflow user interface, in accordance with one embodiment of the invention.

FIG. 5 illustrates an exemplary query definition user interface, in accordance with one embodiment of the invention.

FIGS. 6A-6C illustrate exemplary property forms, in accordance with one embodiment of the invention.

FIG. 7 illustrates an exemplary prediction repair user interface, in accordance with one embodiment of the invention.

FIG. 8 illustrates an exemplary network architecture in which embodiments of the invention may operate.

FIG. 9 illustrates a diagrammatic representation of a machine in the exemplary form of a computer system, in accordance with one embodiment of the present invention

### DETAILED DESCRIPTION OF THE INVENTION

Methods and systems for facilitating user-specified configuration of prediction services in a manufacturing facility are discussed. In one embodiment, a workflow user interface is presented to allow a user to specify a workflow for providing predictions pertaining to a future of a manufacturing facility. The workflow identifies a sequence of operations to be performed for providing the predictions. When the user selects the operations, they are displayed in the workflow user interface. In addition, the user can specify properties for each operation in the workflow user interface. The workflow with the properties are then stored in a repository for subsequent execution in response to a workflow trigger. The repository can represent any type of data storage, including, for example, relational or hierarchical databases (proprietary or commercial), flat files, application or shared memory, etc.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.)), etc.

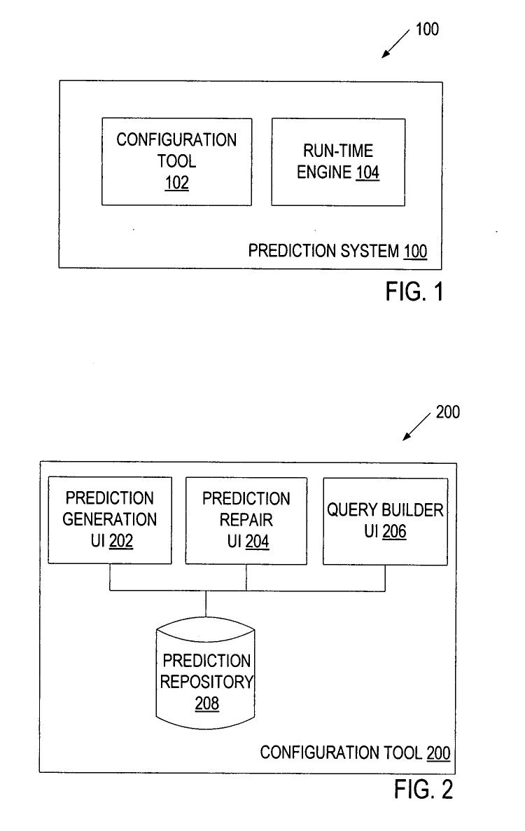

FIG. 1 illustrates one embodiment of a prediction system 100 in an automated manufacturing facility (e.g., a semiconductor fabrication facility). The prediction system 100 builds predictions about the future of the manufacturing facility and its components. The predictions generated by the prediction system 100 may specify, for example, a future state of the equipment in the manufacturing facility, the quantity and composition of the product that will be manufactured in the facility, the number of operators needed by the facility to manufacture this product, the estimated time a product will finish a given process operation and/or be available for processing at a given step, the estimated time a preventative maintenance operation should be performed on equipment, etc.

The prediction system may include a configuration tool 102 and a run-time engine 104. The configuration tool 102 facilitates user-specified configuration of prediction services in the manufacturing facility. In particular, the configuration tool 102 allows a user to customize prediction services for the needs of a specific manufacturing facility. In one embodiment, the configuration tool 102 presents a workflow user interface that allows a user to specify a workflow for providing predictions pertaining to the future of the manufacturing facility. The workflow identifies a sequence of operations to be performed for generating the predictions. The workflow may be a full prediction workflow or a prediction repair workflow. The operations included in the full prediction workflow may include, for example, initiating the workflow, collecting data about the manufacturing facility, generating predictions based on the collected data, and making the predictions available to requestors. The prediction repair workflow is intended for performing incremental updates to the predictions in-between full prediction generations. The operations included in the prediction repair workflow may include, for example, detecting a critical event, evaluating the impact of the critical event on the existing predictions, and updating the existing predictions according to the impact of the critical event.

When the user selects the operations for a workflow, they are displayed in the workflow user interface. In addition, the user can specify properties for each operation in the workflow user interface. The workflow with the properties are then stored in a repository. The repository can represent any type of data storage, including, for example, relational or hierarchical databases (proprietary or commercial), flat files, application or shared memory, etc.

The run-time engine 104 retrieves the workflow from the repository and executes it. The operation of the run-time engine 104 may start in response to a workflow trigger. The workflow trigger, which may be specified as part of the workflow properties, can be, for example, a user request, a predefined event, or a scheduled time. Depending on the operations included in the workflow, the run-time engine 104 may provide predictions by collecting information about the manufacturing facility, generating predictions based on the collected information, and providing the predictions to one or more requesters. The information about the manufacturing facility may include, for example, description of equipment in the manufacturing facility, capability of different pieces of the equipment, current state of equipment, what product is being currently processed by equipment, the characteristics of this product, etc.

FIG. 2 is a block diagram of one embodiment of a configuration tool 200. The configuration tool 200 provides a prediction generation user interface (UI) 202 that allows a user to specify operations for a full prediction workflow and to specify the order for executing the operations. The operations may be selected from a designated area in the prediction generation UI 202. Alternatively, the prediction generation UI 202 can display a template workflow that can be modified by the user. In particular, the user can delete some operations from the template workflow, add new operations, or modify some operations or their properties. The resulting workflow is stored in a data base 208 and can be retrieved every time the user wants to view it or modify it.

As discussed above, one of the operations included in the full prediction workflow may pertain to data collection. For data collection operations, the configuration tool 200 provides a query builder UI 206 that allows a user to specify parameters for queries. For example, the query builder UI 206 may receive user selection of source systems to be queried for data, type of data to be collected, query filter information, etc. Exemplary source systems may include various systems of the manufacturing facility such as a manufacturing execution system (MES), a maintenance management system (MMS), a material control system (MCS), an equipment control system (ECS), an inventory control system (ICS), a computer integrated manufacturing system (CIM), various databases (including but not limited to flat-file storage systems such as Excel files), etc. In one embodiment, the query builder UI 206 provides template queries that can be modified by the user based on desired source systems and data to be collected from these source systems. The resulting queries can be stored in the prediction repository 208 and can be retrieved every time the user wants to view them or modify them.

A prediction repair UI 204 allows a user to specify a prediction repair workflow for performing incremental updates to the predictions in-between full prediction generations. The operations may be selected from a designated area in the prediction repair UI 204. Alternatively, the prediction repair UI 204 can display a template workflow that can be modified by the user. The resulting prediction workflow is stored in the prediction repository 208. The operations included in the prediction repair workflow may include, for example, detecting a critical event, evaluating the impact of the critical event on the existing predictions, and updating the existing predictions according to the impact of the critical event on the predictions. The evaluation of the impact may include submitting a query to the source system for detailed information about the critical event. A user can specify parameters of such queries using the query builder UI 206 discussed above. The query builder UI 206 may assist the user in building the query from scratch or using a pre-generated template query.

In one embodiment, the prediction generation UI 202 and the prediction repair UI 204 allows a user to specify properties for each operation included in the workflow. In particular, upon a user request, the UI 202 or 204 may present a window with a form containing one or more property fields for a specific operation. The user request for a property form may be generated, for example, when the user double clicks the operation indicator in the UI, right clicks the operation indicator in the UI and selects a property option in the displayed list, etc. The properties may include, for example, a time horizon (e.g., a time interval between now and a point in the future for which predictions should be generated), a workflow trigger, data source systems, query parameters, entities to be predicted, a prediction generation mechanism (e.g., prediction simulation or prediction calculation), recipients of predictions, conditions for publishing predictions, an event causing prediction repair, data to be obtained in response to this event, type of repair (prediction data update or regeneration), etc. The specified properties are stored in the prediction repository 208, along with the corresponding workflow.

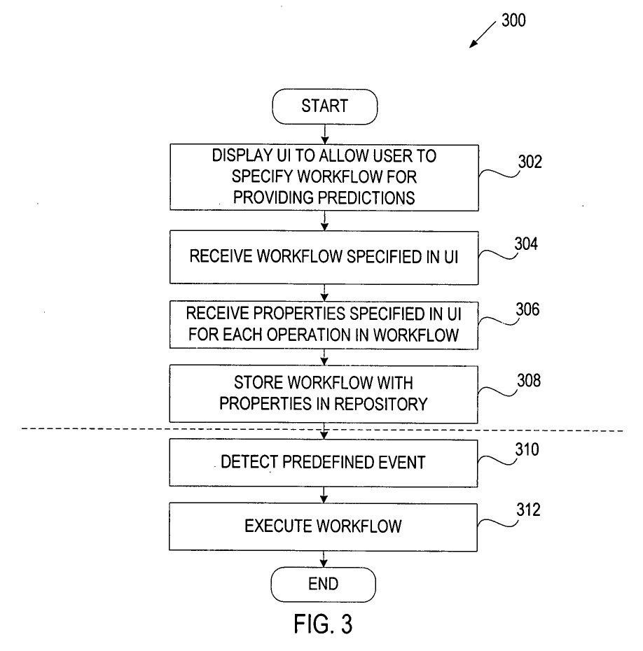

FIG. 3 is a flow diagram of one embodiment of a method 300 for facilitating user-specified configuration of prediction services in an automated manufacturing facility. The method may be performed by processing logic that may comprise hardware (e.g., circuitry, dedicated logic, etc.), software (such as run on a general purpose computer system or a dedicated machine), or a combination of both. In one embodiment, processing logic resides in a prediction system 100 of FIG. 1.

Referring to FIG. 3, processing logic begins with displaying a UI that allows a user to specify a workflow for providing predictions (block 302). The workflow includes a sequence of operations. The UI presents the operations using operation indicators that visual illustrate the functionality associated with the operations (e.g., using symbols, images, shapes, color, size, labels, etc.). The UI also graphically illustrates the order for the executing the operations (e.g., using arrows or other visual indicators).

At block 304, processing logic receives the workflow specified in the UI. The workflow may be a full prediction workflow or a prediction repair workflow. The operations included in the full prediction workflow may involve, for example, initiating the workflow, collecting data about the manufacturing facility, generating predictions based on the collected data, and making the predictions available to requesters. The operations included in the prediction repair workflow may involve, for example, detecting a critical event, evaluating the impact of the critical event on the existing predictions, and updating the existing predictions according to the impact of the critical event.

At block 306, processing logic receives properties specified in the UI for operations included in the workflow. The properties may include, for example, a time horizon, a workflow trigger, data source systems, query parameters, entities to be predicted, a prediction generation mechanism, recipients of predictions, conditions for publishing predictions, an event causing prediction repair, data to be obtained in response to this event, type of repair, etc. At block 306, processing logic stores the workflow with the properties in a repository.

Subsequently, at runtime, processing logic detects a predefined event (block 310) and executes the above workflow (block 312). A predefined event may be a user request (manual initiation) to execute the workflow, a scheduled time, a critical event occurred in the manufacturing facility (e.g., unexpected downtime of equipment), etc.

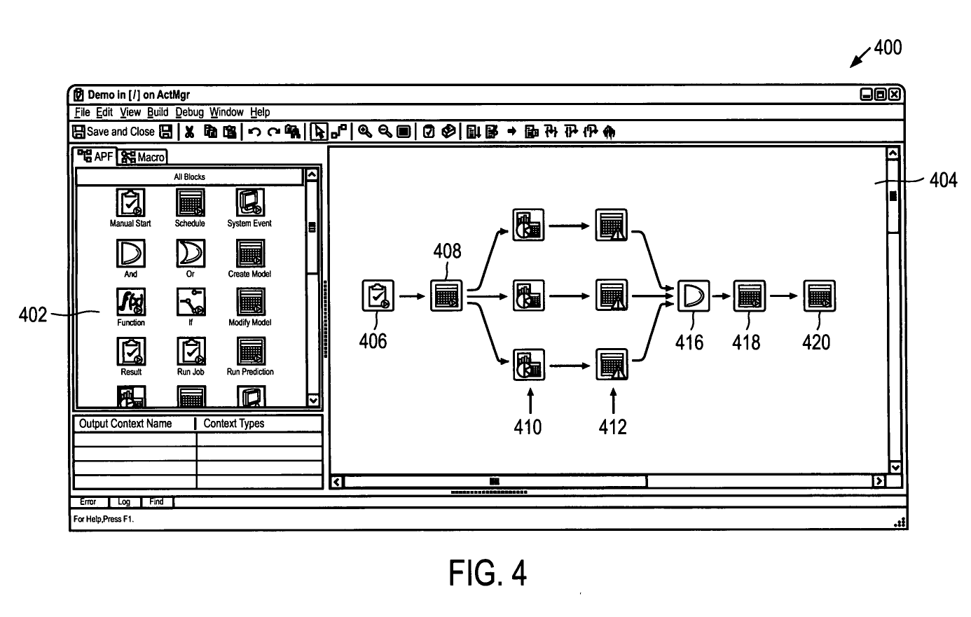

FIGS. 4-7 illustrate exemplary UIs provided by a configuration tool, according to some embodiments of the invention. FIG. 4 illustrates an exemplary workflow UI 400 that includes an operation selection area 402 and a working area 404. The operation selection area 402 presents different operation indicators that can be selected by a user for a workflow. The operation indicators are displayed as blocks with text labels and thumbnail images illustrating the functionality of operations. The user can select a desired operation by dragging a relevant indicator from the operation selection area 402 to the working area 404 and dropping this indicator in the working area 404.

The working area 404 may display a sequence of operations selected by the user from the operation selection area 402. Alternatively, the working area 404 may display a template workflow provided as part of the workflow UI 400. The sequence of operations displayed in the working area 404 can be modified by deleting some of the operations and/or adding new operations selected from the operation selection area 402. The user can specify the order for executing the operations, or the workflow UI 400 can automatically generate the order (e.g., arrows) based on how operations are placed in the working area 404 (sequentially, paralleled to each other, etc.).

The workflow displayed in the working area 404 is a full prediction workflow that includes operations 405 through 420. In particular, operation 406 defines the initiation of the workflow (e.g., based on a trigger). Operation 408 represents creation of a prediction data model, which defines a set of data needed for generating predictions. Operations 410 represent run of queries to obtain data needed for the prediction data model from source systems. Operations 412 modify the prediction data model with results of individual queries 410. Operation 416 signifies the aggregation of different portions of the prediction data model updated with results of individual queries. Operation 418 represents prediction generation. The prediction generation operation 418 may be performed by calculating predictions using one or more formulas. Alternatively, the prediction generation operation 418 may run simulation to generate predictions. In particular, the equipment behavior may be simulated step by step, synchronized in time, until reaching a specific point in the future (based on a time horizon provided by the user). Each transition of the product and the equipment may be recorded, with the final set of data representing prediction. The operation 420 represents prediction publication (e.g., making predictions available to subscribers of prediction services or any other qualified recipients of prediction information).

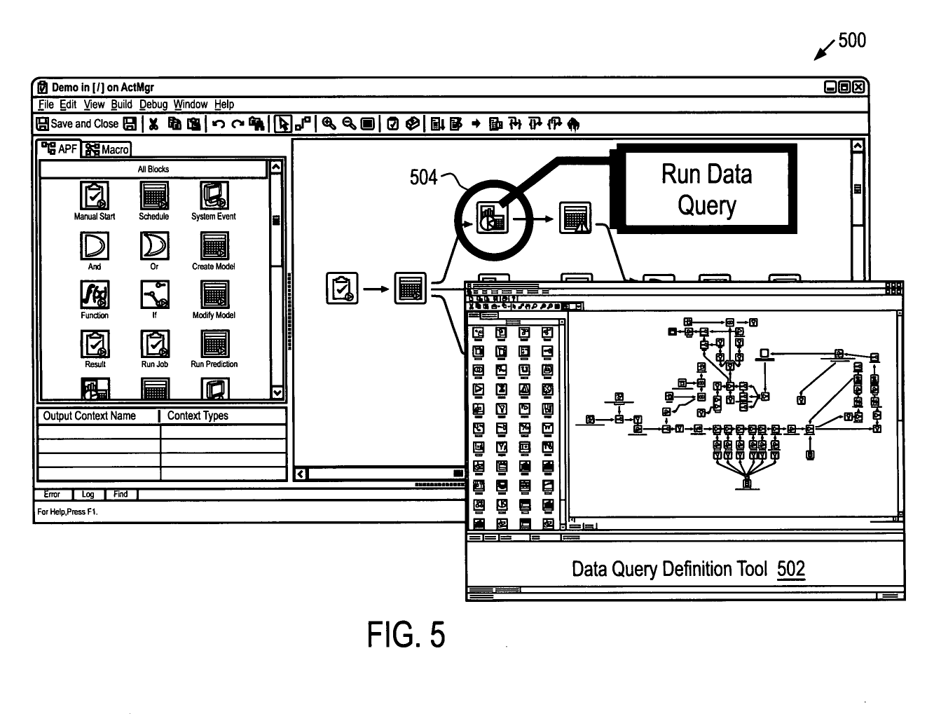

FIG. 5 illustrates an exemplary query definition tool UI 502, in accordance with one embodiment of the invention. When a user defines a run data query operation 504 in a workflow UI 500, a data query definition tool UI 502 is provided to allow the user to specify data source systems that should be queried about data required for a prediction data model. In addition, the user can specify query parameters (e.g., data to be requested, filters, etc.). The source systems may include, for example, MES, MMS, MCS, ECS, ICS, etc. In one embodiment, the data query definition tool UI 502 provides template queries that can be modified by the user based on desired source systems and data to be collected from these source systems.

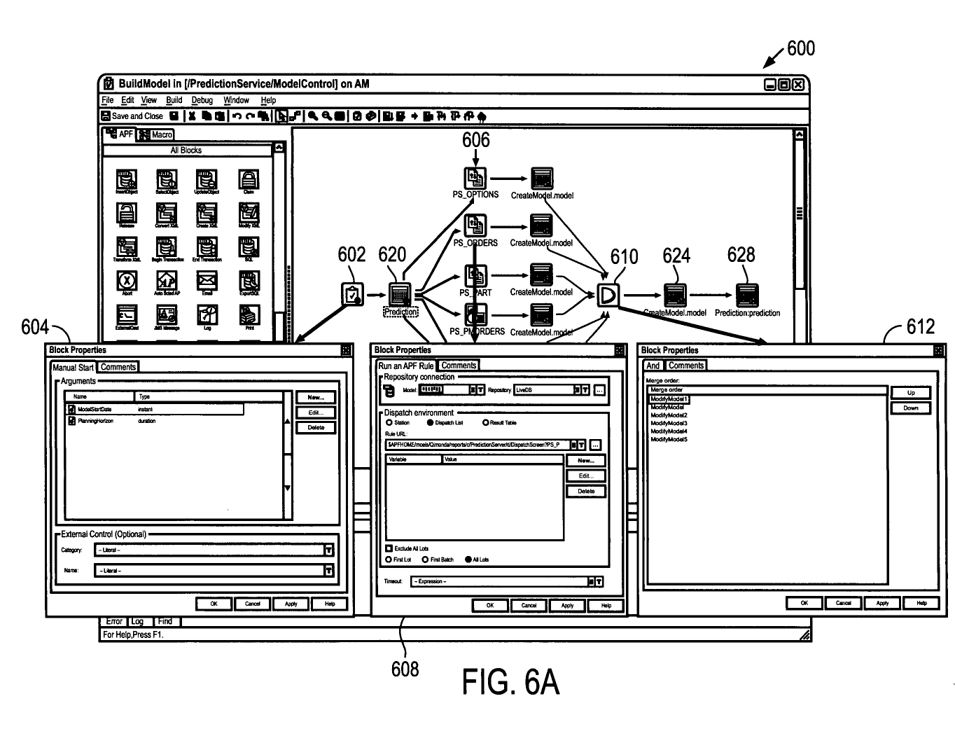

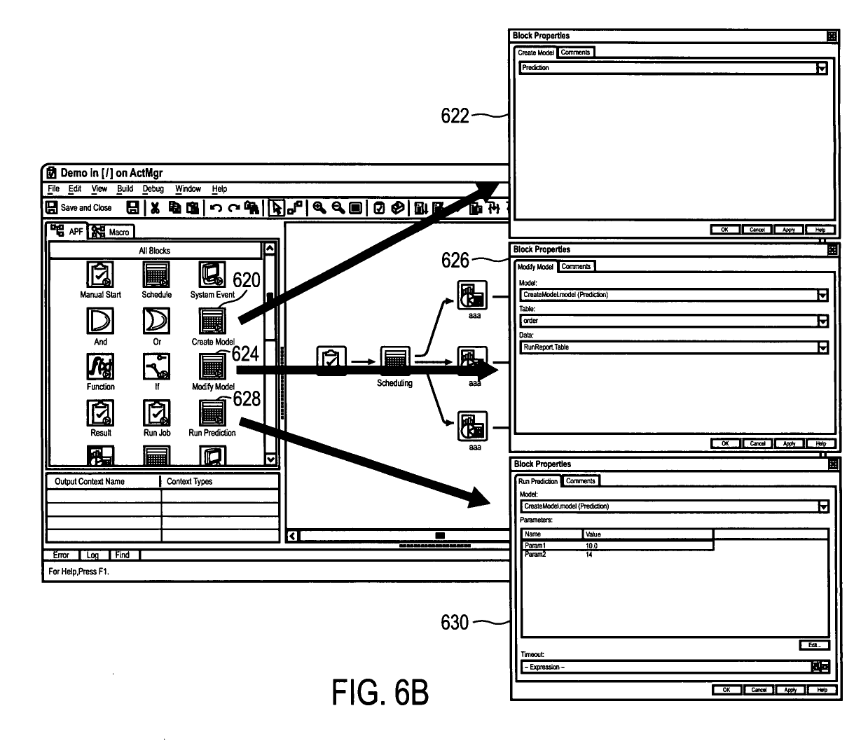

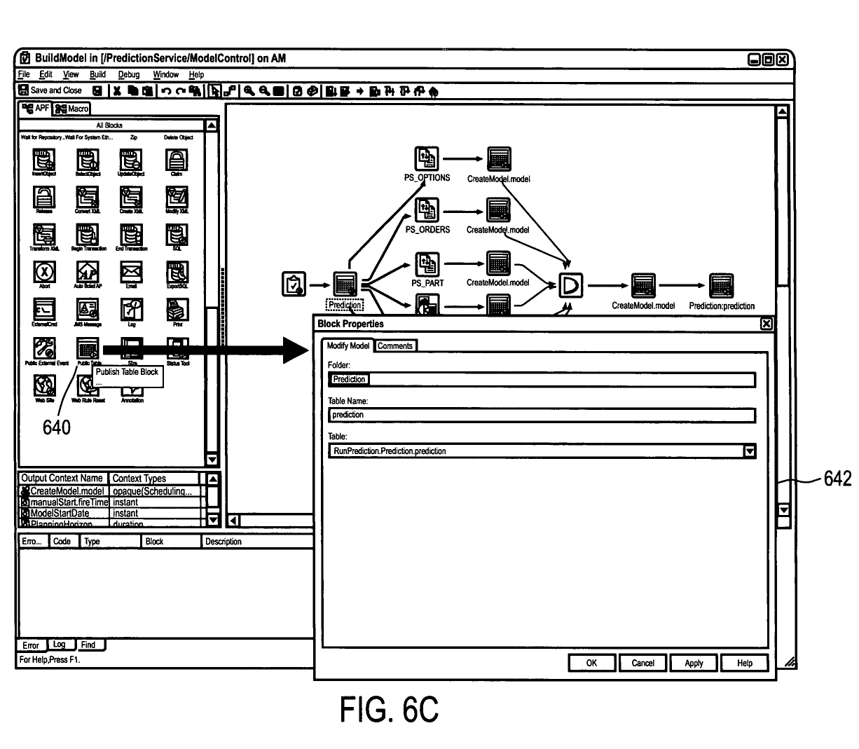

FIGS. 6A-6C illustrate exemplary property forms, in accordance with one embodiment of the invention. Each property form corresponds to a specific operation. In particular, in one embodiment, when a user right clicks a respective operation indicator in a workflow UI, a list of options appears. If the user selects a property option from the list, a window opens displaying a property form with one or more fields.

FIG. 6A shows exemplary property forms 604, 608 and 612. The property form 604 corresponds to a workflow initiation operation 602 displayed in a workflow interface 600. The property form 604 specifies a trigger for initiating the workflow (e.g., manual user request) and a time horizon (e.g., a time interval defining a point in the future for which prediction should be generated).

The property form 608 corresponds to a run query operation 606. The property form 608 identifies a prediction data model and query to be used for the operation 606. The property form 612 corresponds to an aggregation operation 610 and identifies the operations which results should be aggregated.

Exemplary forms for a create model operation 620, a modify model 607 and a run prediction operation 624 are shown in FIG. 6B. An exemplary property form for a prediction publication operation 628 is shown in FIG. 6C.

FIG. 6B shows exemplary property forms 622, 626 and 630. The property form 622 corresponds to a create model operation 620 illustrated in the operation selection area of the workflow UI. The property form 622 specifies the schema of a prediction data model. The property form 626 corresponds to a modify model operation 624 illustrated in the operation selection area. The property form 626 specifies the model, one or more tables of the model and a query result to be added to the table(s) of the model. The property form 630 corresponds to a run prediction operation 628 illustrated in the operation selection area. The property form 630 specifies the prediction data model to be used and parameters for generating predictions.

FIG. 6C shows an exemplary property form 642. The property form 642 corresponds to a prediction publication operation 640 illustrated in the operation selection area of the workflow UI. The property form 642 specifies where generated predictions should be stored.

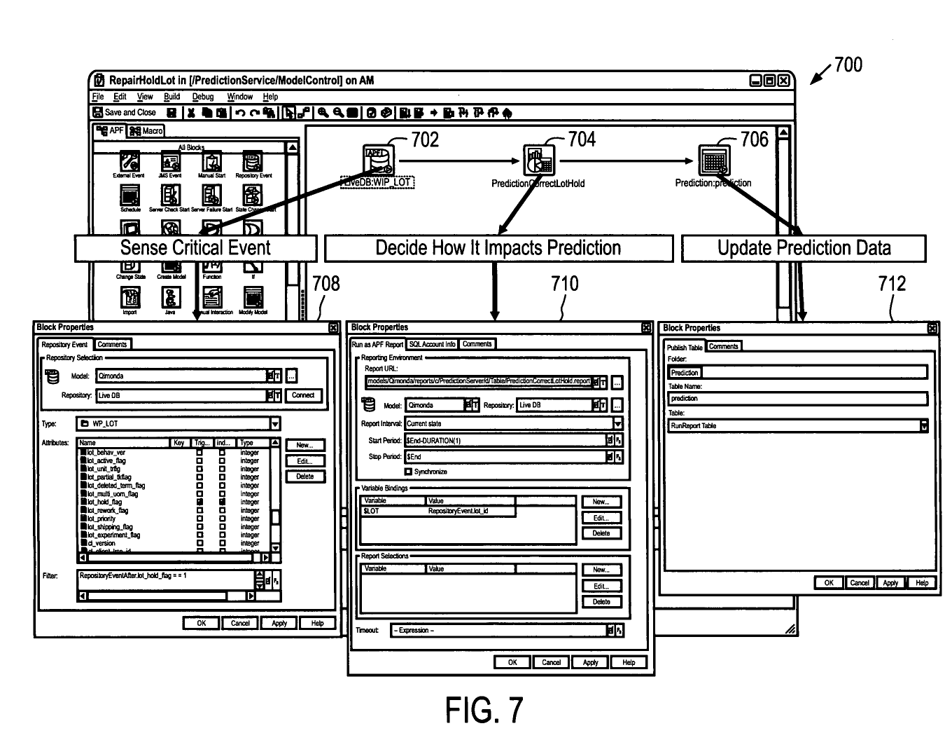

FIG. 7 illustrates an exemplary workflow UI 700 that displays a prediction repair workflow. The prediction repair workflow includes a sense critical event operation 702, an event impact evaluation operation 704, and a prediction data update operation 706.

A property form 708 corresponds to the operation 702 and specifies which critical event should trigger the prediction repair workflow. As shown, a change in value of a lot hold flag constitutes a critical event. This event may be detected upon receiving a notification from a source system.

A property form 710 corresponds to the impact evaluation operation 704 and specifies what details should be obtained to evaluate the impact of the critical event on the existing predictions. For example, if processing of a lot of wafers in the MES is put on hold, a query may be sent to the MES to obtain all information about this lot. If the result of the query indicates that a problem which caused the interruption will be fixed during a specific time interval, then a complete regeneration of the existing predictions is not needed, and predictions may be repaired by updating only the prediction data affected by this event. A property form 712 corresponds to the prediction publication operation 706 and specifies the table in a prediction database that should be updated as a result of the prediction repair.

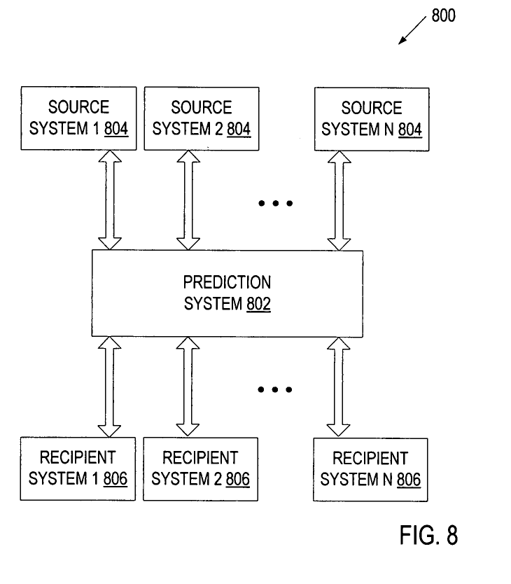

FIG. 8 illustrates an exemplary network architecture 800 in which embodiments of the present invention may operate. The network architecture 800 may represent an automated manufacturing facility (e.g., a semiconductor fabrication facility) and may include a prediction system 802, a set of source systems 804 and a set of recipient systems 806. The prediction system 802 may communicate with the source systems 804 and the recipient systems 806 via a network. The network may be a public network (e.g., Internet) or a private network (e.g., local area network (LAN)).

The source systems 804 may include, for example, MES, MMS, MCS, ECS and ICS. The recipient systems 806 may include some or all of the source systems 104, as well as some other systems such as a scheduler, a dispatcher, etc. The prediction system 802 may be hosted by one or more computers with one or more internal or external storage devices.

The prediction system 802 provides prediction services in the manufacturing facility. A configuration tool of the prediction system 802 allows users to customize the prediction services for the needs of the specific manufacturing facility. The customized prediction services build predictions by collecting data from the source systems 804, using the collected data to generate predictions, and providing the predictions to the recipient system 806. The predictions generated by the prediction system 802 may specify, for example, a future state of the equipment in the manufacturing facility, the quantity and composition of the product that will be manufactured in the facility, the number of operators needed by the facility to manufacture this product, the estimated time a product will finish a given process operation and/or be available for processing at a given step, the estimated time a preventative maintenance operation should be performed on equipment, etc.

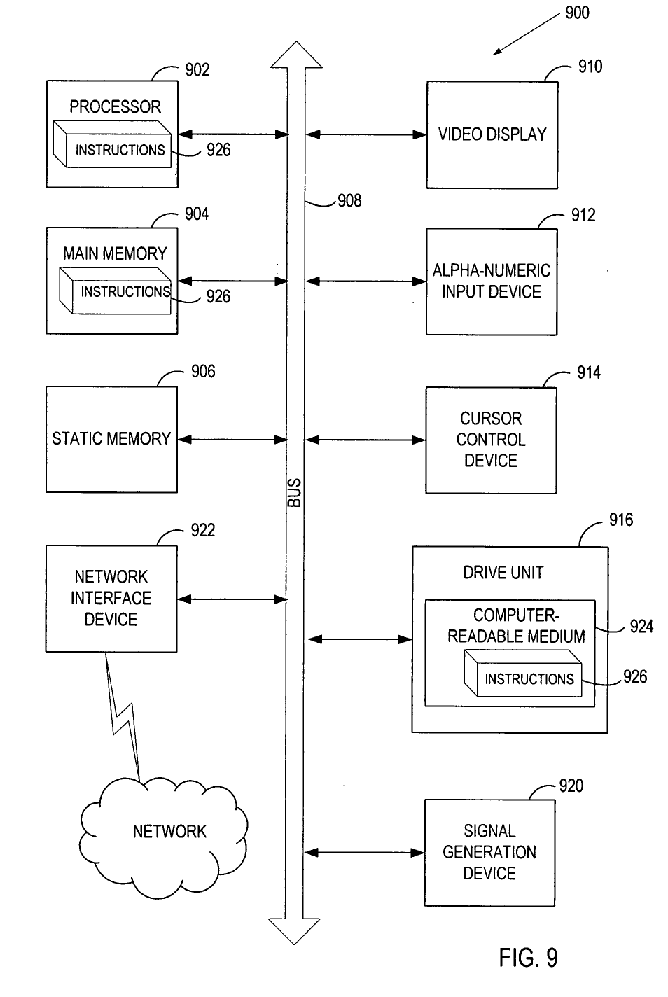

FIG. 9 illustrates a diagrammatic representation of a machine in the exemplary form of a computer system 900 within which a set of instructions, for causing the machine to perform any one or more of the methodologies discussed herein, may be executed. The machine may be connected (e.g., networked) to other machines in a LAN, an intranet, an extranet, or the Internet. The machine may operate in a client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device (processor) 902, a main memory 904 (e.g., read-only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which may communicate with each other via a bus 930. Alternatively, the processing device 902 may be connected to memory 904 and/or 906 directly or via some other connectivity means.

Processing device 902 represents one or more general-purpose processing devices such as a microprocessor, central processing unit, or the like. More particularly, the processing device 902 may be complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 902 is configured to execute processing logic 926 for performing the operations and steps discussed herein.

The computer system 900 may further include a network interface device 908 and/or a signal generation device 916. It also may or may not include a video display unit (e.g., a liquid crystal display (LCD) or a cathode ray tube (CRT)), an alphanumeric input device (e.g., a keyboard), and/or a cursor control device (e.g., a mouse).

The computer system 900 may or may not include a secondary memory 918 (e.g., a data storage device) having a machine-accessible storage medium 931 on which is stored one or more sets of instructions (e.g., software 922) embodying any one or more of the methodologies or functions described herein. The software 922 may also reside, completely or at least partially, within the main memory 904 and/or within the processing device 902 during execution thereof by the computer system 900, the main memory 904 and the processing device 902 also constituting machine-accessible storage media. The software 922 may further be transmitted or received over a network 920 via the network interface device 908.

While the machine-accessible storage medium 931 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A computerized method comprising:
displaying a workflow user interface allowing a user to specify a workflow for providing predictions pertaining to a future of a manufacturing facility, the workflow identifying a sequence of operations to be performed for providing the predictions;
displaying the workflow specified by the user in the workflow user interface;
receiving, via the workflow user interface, one or more properties for each operation identified in the workflow; and
storing the workflow with the properties in a repository for subsequent execution in response to a workflow trigger.

2. The method of claim 1 wherein the workflow trigger comprises any one of a user request, a scheduled time, or a predefined event.

3. The method of claim 1 wherein:
the user workflow interface comprises an operation selection area and a working area;
the operation selection area presents a plurality of operation indicators for selecting operations to be included in the workflow; and
the working area presents a subset of operation indicators selected by the user from the operation selection area.

4. The method of claim 3 wherein each operation indicator graphically illustrates a corresponding operation using at least one of an image, color or size.

5. The method of claim 1 wherein the user interface graphically illustrates the order for executing the operations.

6. The method of claim 1 wherein the workflow is any one of a full prediction workflow or a prediction repair workflow.

7. The method of claim 6 wherein the sequence of operations in the full prediction workflow comprises one or more of a workflow initiation, a prediction model creation, a data query run for obtaining data from one or more source systems of the manufacturing facility, a prediction model modification, a prediction generation, or a prediction publication.

8. The method of claim 6 wherein the sequence of operations in the prediction repair workflow comprises one or more of an event detection, an event impact evaluation, or a prediction data update.

9. The method of claim 7 further comprising:
displaying a query definition user interface to allow the user to define one or more queries, wherein defining each query comprises specifying a source system and data to be retrieved from the source system.

10. The method of claim 9 wherein the source system is any one of a manufacturing execution system (MES), a maintenance management system (MMS), a material control system (MCS), an equipment control system (ECS), an inventory control system (ICS), or a computer integrated manufacturing (CIM) system.

11. The method of claim 1 wherein receiving one or more properties for each operation comprises:
upon a user request, presenting for a window with a form having one or more property fields for an operation; and
receiving, via the property fields, user input specifying desired properties for the operation.

12. The method of claim 11 wherein the properties comprise one or more of a time horizon, the workflow trigger, one or more source systems, query parameters, entities to be predicted, a prediction generation mechanism, one or more recipients of predictions, conditions for publishing predictions, an event causing prediction repair, data to be obtained in response to the event, or a type of repair.

13. The method of claim 1 wherein the predictions pertaining to the future of the manufacturing facility include information about at least one of a future state of equipment in the facility, a composition of lots to be manufactured, a number of lots to be manufactured, a number of operators needed by the facility, or materials needed for the facility.

14. A computer-readable medium having executable instructions to cause a computer system to perform a method comprising:
displaying a workflow user interface allowing a user to specify a workflow for providing predictions pertaining to a future of a manufacturing facility, the workflow identifying a sequence of operations to be performed for providing the predictions;
displaying the workflow specified by the user in the workflow user interface;
receiving, via the workflow user interface, one or more properties for each operation identified in the workflow; and
storing the workflow with the properties in a repository for subsequent execution in response to a workflow trigger.

15. The computer-readable medium of claim 14 wherein the workflow trigger comprises any one of a user request, a scheduled time, or a predefined event.

16. The computer-readable medium of claim 14 wherein:
the user workflow interface comprises an operation selection area and a working area;
the operation selection area presents a plurality of operation indicators for selecting operations to be included in the workflow; and
the working area presents a subset of operation indicators selected by the user from the operation selection area.

17. The computer-readable medium of claim 14 wherein:
the workflow is a full prediction workflow; and
the sequence of operations in the full prediction workflow comprises one or more of a workflow initiation, a prediction model creation, a data query run for obtaining data from one or more source systems of the manufacturing facility, a prediction model modification, a prediction generation, or a prediction publication.

18. The computer-readable medium of claim 14 wherein:
the workflow is a prediction generation workflow; and
the sequence of operations in the prediction repair workflow comprises one or more of an event detection, an event impact evaluation, or a prediction data update.

19. A system comprising:
a configuration tool to display a workflow user interface allowing a user to specify a workflow for providing predictions pertaining to a future of a manufacturing facility, the workflow identifying a sequence of operations to be performed for providing the predictions, to display the workflow specified by the user in the workflow user interface, to receive, via the workflow user interface, one or more properties for each operation identified in the workflow; and
a prediction repository, coupled to the configuration tool to store the workflow with the properties for subsequent execution in response to a workflow trigger.

20. The system of claim 19 wherein:
the user workflow interface comprises an operation selection area and a working area;
the operation selection area presents a plurality of operation indicators for selecting operations to be included in the workflow; and
the working area presents a subset of operation indicators selected by the user from the operation selection area.

21. The system of claim 19 wherein:
the workflow is a full prediction workflow; and
the sequence of operations in the full prediction workflow comprises one or more of a workflow initiation, a prediction model creation, a data query run for obtaining data from one or more source systems of the manufacturing facility, a prediction model modification, a prediction generation, or a prediction publication.

22. The system of claim 19 wherein:
the workflow is a prediction generation workflow; and
the sequence of operations in the prediction repair workflow comprises one or more of an event detection, an event impact evaluation, or a prediction data update.
